(19) United States
(12) Patent Application Publication
(10) Pub. No.: US 2026/0062175 A1
(43) Pub. Date: Mar. 5, 2026

(54) DOCK CADDIE

(71) Applicant: Gary Berenyi, Daniel Island, SC (US)

(72) Inventor: Gary BERENYI, Daniel Island, SC (US)

(21) Appl. No.: 18/825,538

(22) Filed: Sep. 5, 2024

(51) Int. Cl. B65D 25/24; B65D 1/34

(52) U.S. Cl. CPC B65D 25/24; B65D 1/34

(57) ABSTRACT

A dock caddie is translatable along a dock having a first dock rail including a first top surface and a first side surface and a second dock rail including a second top surface and a second side surface. The dock caddie includes a frame member. A first wheel configured to ride on the first top surface is arranged on the frame member. A second wheel configured to ride along the second top surface is arranged on the frame member. The first wheel and the second wheel are adjustably positionable on the frame member. A first guide wheel assembly configured to ride along the first side surface is arranged on the frame member. A second guide wheel assembly configured to ride along the second side surface is arranged on the frame member. The first guide wheel assembly and the second guide wheel assembly are selectively adjustably positionable on the frame member.

### FIELD

The present disclosure relates to the art of article transport devices and, more particularly, to a dock caddie that assists in transporting articles to and from a boat.

### BACKGROUND

This section provides background information related to the present disclosure which is not necessarily prior art.

When heading out for a day on the water in a boat, many individuals take a lot of gear. The gear can be associated with water sports, fishing, eating, cooking, or any other activity that can take place on or by the water. Often times the boat is moored to a dock in a marina. Loading the gear out of a vehicle down the dock and into the boat often times takes several trips. Likewise, loading the gear from the boat up the dock back to the vehicle can take as many or more trips.

### SUMMARY

This section provides a general summary of the disclosure and is not a comprehensive disclosure of its full scope or all of its features.

A dock caddie, in accordance with the present disclosure, is translatable along a dock having a first dock rail including a first top surface and a first side surface and a second dock rail including a second top surface and a second side surface. The dock caddie includes a frame including a first frame member having a first end and a second end defining a first frame axis, a second frame member including a first end portion and a second end portion defining a second frame axis parallel to the first frame axis, a third frame member extending between and connecting the first end with the first end portion, and a fourth frame member extending between and connecting the second end and the second end portion. A first wheel configured to ride on the first top surface is arranged on the first frame member and is rotatable about a first axis of rotation. A second wheel configured to ride along the second top surface is arranged on the first frame member and is rotatable about the first axis of rotation. The first wheel and the second wheel are selectively adjustably positionable between the first end and the second end of the first frame member. A first guide wheel assembly configured to ride along the first side surface is arranged on the first frame member and is rotatable about a second axis of rotation that is perpendicular relative to the first axis of rotation. A second guide wheel assembly configured to ride along the second side surface is arranged on the first frame member and is rotatable about the second axis of rotation. The first guide wheel assembly and the second guide wheel assembly are selectively adjustably positionable between the first end and the second end of the first frame member.

In other features, a tray is removeably supported in the frame.

In other features, the tray includes a plurality of trays, each of the plurality of trays including at least one compartment.

In other features, a tray cover is detachably connected to the tray.

In other features, a first adjustable support member extends from the first frame member, the first adjustable support member supporting the first wheel and the first guide wheel assembly, and a second adjustable support member extends from the first frame member spaced from the first adjustable support member along the first frame axis, the second adjustable support member supporting the second wheel and the second guide wheel assembly.

In other features, the first adjustable support member includes a mounting plate configured to connect with the first frame member, the mounting plate including a first wheel support and a second wheel support, the first wheel being supported between the first wheel support and the second wheel support.

In other features, the first wheel includes a first wheel element and a second wheel element mounted to a first axle, the first axle being rotatably supported between the first wheel support and the second wheel support.

In other features, a guide wheel support extends from the mounting plate, the first guide wheel assembly being selectively connected to the guide wheel support.

In other features, the guide wheel support includes a plurality of adjustment openings, each of the plurality of adjustment openings being spaced a selected distance from the mounting plate.

In other features, a sleeve is selectively connected to the guide wheel support through at least one of the plurality of adjustment openings.

In other features, the first guide wheel assembly includes a wheel yoke including a wheel mount supporting a wheel pin, the wheel pin being slidingly received by the sleeve.

In other features, a spring is arranged between the wheel yoke and the sleeve, the spring biasing the wheel yoke laterally outwardly from the first adjustable support member toward the first side surface of the first dock rail.

In other features, the first frame member includes an upper surface, a lower surface, and a first plurality of openings extending between the upper surface and the lower surface adjacent to the first end and a second plurality of openings extending between the upper surface and the lower surface adjacent to the second end.

In other features, the first adjustable support member is connected to the lower surface of the first frame member through select ones of the first plurality of openings and the second adjustable support member is connected to the lower surface of the first frame member through select ones of the second plurality of openings.

In other features, the first adjustable support member is spaced from the second adjustable support member such that the first wheel rests on the first top surface and the second wheel rests on the second top surface.

In other features, the guide wheel support is spaced from the first wheel such that the first guide wheel assembly rides along the first side surface.

In other features, a third wheel is configured to ride on the first top surface, the third wheel is arranged on the second frame member and is rotatable about the first axis, a fourth wheel is configured to ride along the second top surface, the fourth wheel is arranged on the second frame member and is rotatable about the first axis of rotation, the third wheel and the fourth wheel being selectively adjustably positionable between the first end portion and the second end portion, a third guide wheel assembly is to ride along the first side surface, the third guide wheel assembly is arranged on the second frame member and is rotatable about a second axis of rotation that is perpendicular relative to the first axis of rotation, and a fourth guide wheel assembly is configured to ride along the second side surface, the fourth guide wheel assembly is arranged on the second frame member and is rotatable about the second axis of rotation, the third guide wheel assembly and the fourth guide wheel assembly being selectively adjustably positionable between the first end portion and the second end portion.

In other features, a motor is mounted to the second frame member, the motor being operatively connected to one of the third wheel and the fourth wheel.

In other features, a motor controller is operatively connected to the motor, the motor controller being selectively activated to drive the dock caddie along the first dock rail and the second dock rail.

In other features, the motor controller includes an antenna, the motor controller being configured to receive wireless signals directing the dock caddie along the first dock rail and the second dock rail.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a partially exploded view of a dock caddie positioned on a dock railing, in accordance with the present disclosure;

FIG. 2 is an upper left perspective view of the dock caddie of FIG. 1, in accordance with the present disclosure;

FIG. 3 is a front elevational view of the dock caddie of FIG. 2, in accordance with the present disclosure;

FIG. 4 is a detail view of an adjustable support member of the dock caddie of FIG. 2, in accordance with the present disclosure; and

FIG. 5 is an upper left rear perspective view of the dock caddie of FIG. 2, in accordance with the present disclosure.

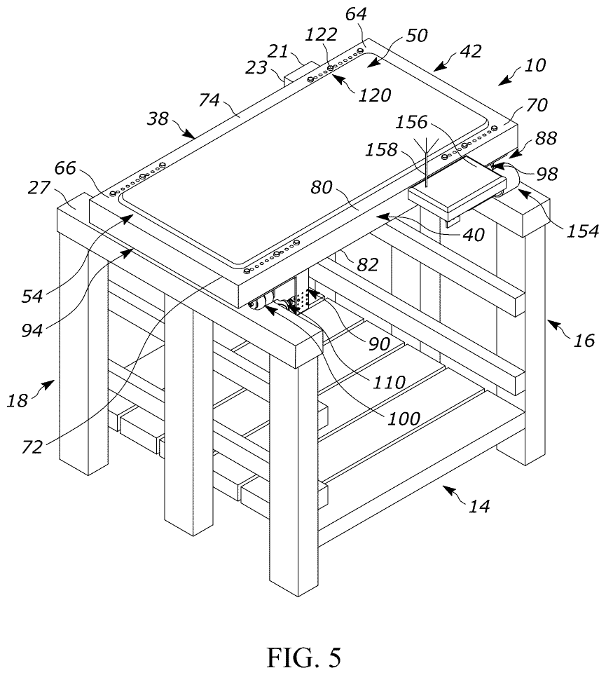

Corresponding reference numerals indicate corresponding parts throughout the several views of the drawings.

### DETAILED DESCRIPTION

Example embodiments will now be described more fully with reference to the accompanying drawings.

Rail transport has been used for years as a system for moving goods from one place to another. Typically, a vehicle, such as a cart or trolley rides on the rails. The rails are spaced apart a known distance. The trolley is designed to include wheels that are similarly spaced. In this manner, the wheels can engage a top surface of the rails as the trolley travels. The wheels often include a lip or flange that prevent slippage off of the rails.

If the goods are tall, heavy, or otherwise easily unbalanced, the trolley may include additional wheels that engage side surfaces of the rails. The additional wheels provide added stability for the trolley. While very effective at transporting goods along rails having a known rail spacing, trolleys are not amenable to being used in different locations having different rail spacings. That is, trolleys do not include wheels having an adjustable wheel spacing. As such, the trolleys are limited for use in specific rail systems.

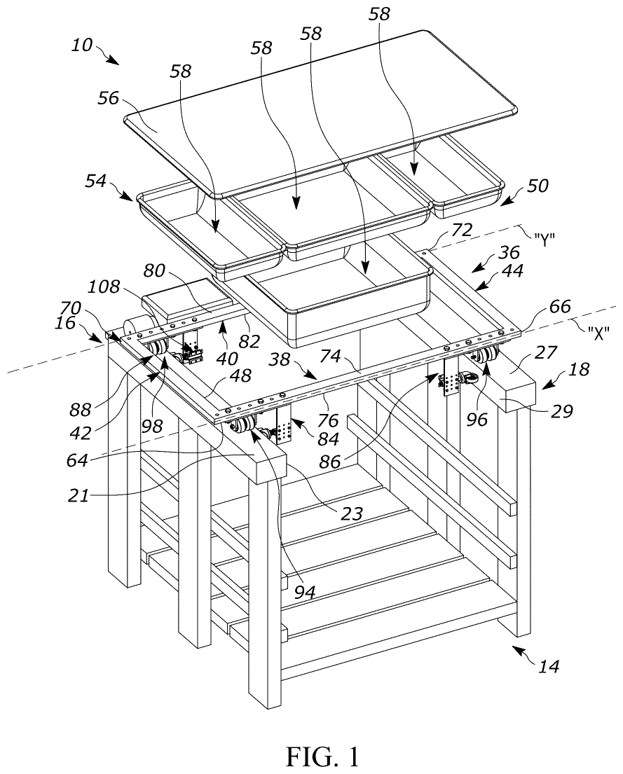

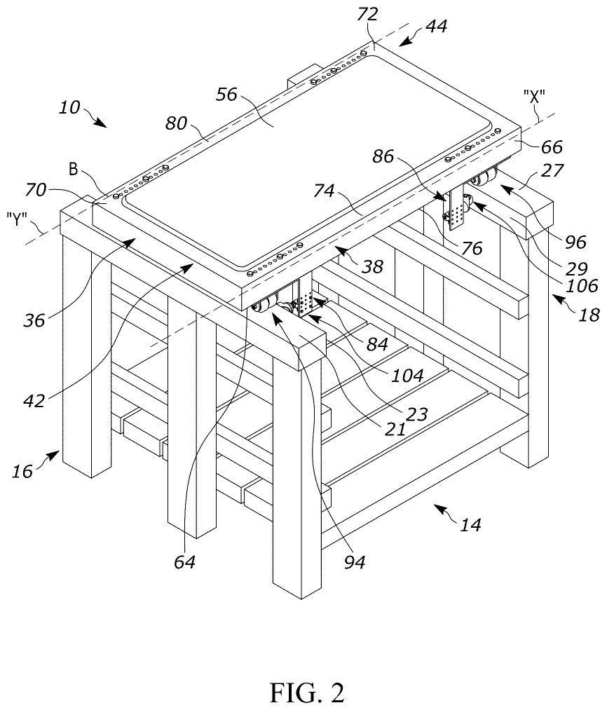

A dock caddie, in accordance with the present disclosure, is indicated generally at 10 in FIGS. 1 and 2. Dock caddie 10 is designed to traverse along a dock 14 supported between a first dock rail 16 and a second dock rail 18. First dock rail 16 includes a first top surface 21 and a first side surface 23 and second dock rail 18 includes a second top surface 27 and a second side surface 29. Dock caddie 10 is shown supported between first top surface 21 and second top surface 27 and engaged with first side surface 23 and second side surface 29 as will be detailed more fully herein.

Dock caddie 10 includes a frame 36 including a first frame member 38 and a second frame member 40 that is arranged parallel to first frame member 38. A third frame member 42 extends between and connects with first frame member 38 and second frame member 40. A fourth frame member 44, spaced from third frame member 42 extends between and connects with first frame member 38 and second frame member 40. Third frame member 43 is arranged substantially parallel to fourth frame member 44. First frame member 38, second frame member 40, third frame member 42 and fourth frame member 44 define an opening 48.

A tray system 50 is supported in opening 48. Tray system 50 includes multiple distinct tray members 54 provided with an integrated tray cover 56. Of course, each of the tray members 54 may include a separate cover (not shown). Tray system 50 includes a plurality of compartments 58 that may be loaded with articles to be transported from, for example, a parked vehicle to a boat and back again. At this point, it should be appreciated that while shown as multiple distinct trays, tray system 50 may be embodied by a single tray with one compartment or a single tray with dividers that form the multiple compartments.

First frame member 38 includes a first end 64 connected to third frame member 42 and a second end 66 connected to fourth frame member 44. A first frame axis “X” is defined between first end 64 and second end 66. Likewise, second frame member 40 includes a first end portion 70 connected to third frame member 42 and a second end portion 72 connected to fourth frame member 44. A second frame axis “Y” is defined between first end portion 70 and second end portion 72. First frame member 38 includes an upper surface 74 and a lower surface 76. Second frame member 40 includes an upper surface portion 80 and a lower surface portion 82.

Dock caddie 10 includes a first adjustable support member 84 and a second adjustable support member 86 connected to first frame member 38, and a third adjustable support member 88 and a fourth adjustable support member 90 connected to second frame member 40. Adjustable support members allow a user to adjust dock caddie 10 to accommodate different dock rail spacings as will be detailed more fully herein. First adjustable support member 84 is mounted to lower surface 76 of first frame member 38 adjacent to first end 64. Second adjustable support member 86 is mounted to lower surface 76 of first frame member 38 adjacent to second end 66. Third adjustable support member 88 is mounted to lower surface portion 82 adjacent to first end portion 70 and fourth adjustable support member 90 is mounted to lower surface portion 82 adjacent to second end portion 72.

A first wheel assembly 94 is connected to first adjustable support member 84 and a second wheel assembly 96 is connected to second adjustable support member 86. A third wheel assembly 98 is connected to third adjustable support member 88, and a fourth wheel assembly 100 is connected to fourth adjustable support member 90. First wheel assembly 94 and third wheel assembly 98 are configured to ride along first top surface 21. Second wheel assembly 96 and fourth wheel assembly 100 are configured to ride along second top surface 27.

Dock caddie 10 also includes a first guide wheel assembly 104 connected to first adjustable support member 84 and a second guide wheel assembly 106 connected to second adjustable support member 86. A third guide wheel assembly 108 is connected to third adjustable support member 88, and a fourth guide wheel assembly 110 is connected to fourth adjustable support member 90. First guide wheel assembly 104 and third guide wheel assembly 108 are configured to ride along first side surface 23 and second guide wheel assembly 106 and fourth guide wheel assembly 110 are configured to ride along second side surface 29.

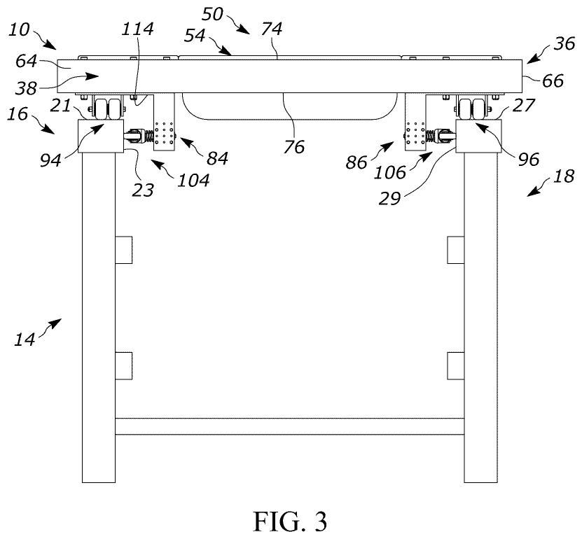

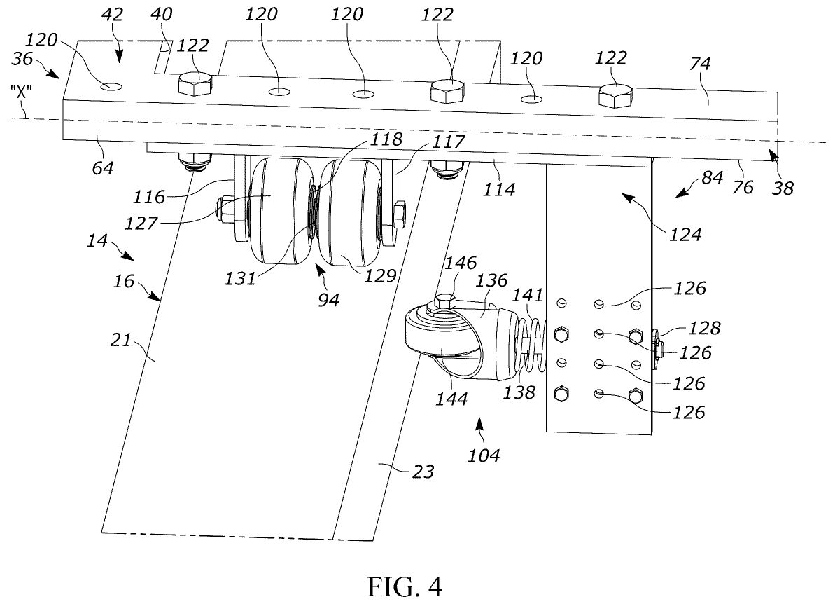

Reference will now follow to FIGS. 3 and 4 in describing first adjustable support member 84 with an understanding that second adjustable support member 86, third adjustable support member 88 and fourth adjustable support member 90 are similarly formed. First adjustable support member 84 includes a mounting plate 114 from which extend a first wheel support 116, a second wheel support 117, and a third wheel support 118. Third wheel support 118 is arranged between first wheel support 116 and second wheel support 117. Mounting plate 114 is detachably connected to lower surface 76 of first frame member 38 at first and 64.

First frame member 38 includes a plurality of passages indicated at 120 at first end 64. Mechanical fasteners 122 may pass through openings 120 and connected with mounting plate 114. With this configuration, first adjustable support member 84 may be connected in different locations on lower surface 76 relative to first end 64 to establish a selected spacing relative to second adjustable support member 86.

A guide wheel support 124 also extends from mounting plate 114. Guide wheel support 124 is spaced from second wheel support 117 in a direction towards second end 66. Guide wheel support 124 includes a plurality of adjustment openings 126 that extend along a vertical axis that is substantially perpendicular relative to first frame axis “X”. A sleeve 128 is connected to at least one of the adjustment opening pairs 126. Sleeve 128 may be connected to guide wheel support 124 along the vertical axis so as to provide additional adjustment options in order to accommodate various geometries of first dock rail 16.

First wheel assembly 94 includes a first wheel element 127 connected to first adjustable support member 84 between first wheel support 116 and third wheel support 118 and a second wheel element 129 connected to first adjustable support member 84 between third wheel support 118 and second wheel support 117. First wheel element 127 and second wheel element 129 are supported upon an axle 131 having an axis of rotation that is substantially parallel to the first frame axis “X”.

In accordance with a non-limiting example, first guide wheel assembly 104 is connected to guide wheel support 124 through sleeve 128. First guide wheel assembly 104 includes a wheel yoke 136 connected to a pin 138. Pin 138 is received in sleeve 128. A locking mechanism (not shown) is passed through pin 138 to prevent undesired removal from sleeve 128. A spring 141 is arranged about pin 138 between wheel yoke 136 and sleeve 128 and a guide wheel 144 is connected to wheel yoke 136 through an axle 146. Axle 146 defines an axis of rotation of guide wheel 144 that is substantially perpendicular relative to first frame axis “X”. Spring 124 acts as a suspension system allowing first guide wheel assembly 104 to accommodate various imperfections in first side surface 23.

In accordance with a non-limiting example, dock caddie 10 may be manually rolled along dock 14 or may be driven remotely depending on a desired configuration. That is, dock caddie 10 may include a motor 154 connected to third wheel assembly 98. The particular mounting location of motor 154 may vary. Motor 154 is connected to a motor controller 156 having an antenna 158. With this configuration, dock caddie 10 may be controlled remotely to transport objects between a vehicle and a boat. That is, one person may load dock caddie 10 at the vehicle. Once loaded, dock caddie 10 may be driven to another person at the boat. This option is particularly advantageous for individuals who have difficulty walking and carrying objects.

At this point it should be understood that the present disclosure describes a system for effortlessly transporting goods between a vehicle and a boat. The dock caddie may be loaded with objects and rolled along the dock rails during loading and/or offloading of the boat. The dock caddie reduces trips carrying multiple, often heavy or awkward objects to save time and effort during loading and unloading. Further, the dock caddie may be provided with a motor option that facilitates powered movement along the dock rails.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The terms “about” and “substantially” are intended to include the degree of error associated with measurement of the particular quantity based upon the equipment available at the time of filing the application. For example, “about” and “substantially” can include a range of ±8% of a given value.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be taken.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A dock caddie that is translatable along a dock having a first dock rail including a first top surface and a first side surface and a second dock rail including a second top surface and a second side surface, the dock caddie comprising:
a frame including a first frame member having a first end and a second end defining a first frame axis, a second frame member including a first end portion and a second end portion defining a second frame axis parallel to the first frame axis, a third frame member extending between and connecting the first end with the first end portion, and a fourth frame member extending between and connecting the second end and the second end portion;
a first wheel configured to ride on the first top surface, the first wheel being arranged on the first frame member and being rotatable about a first axis;
a second wheel configured to ride along the second top surface, the second wheel being arranged on the first frame member and being rotatable about the first axis of rotation, the first wheel and the second wheel being selectively adjustably positionable between the first end and the second end of the first frame member;
a first guide wheel assembly configured to ride along the first side surface, the first guide wheel assembly being arranged on the first frame member and being rotatable about a second axis of rotation that is perpendicular relative to the first axis of rotation; and
a second guide wheel assembly configured to ride along the second side surface, the second guide wheel assembly being arranged on the first frame member and being rotatable about the second axis of rotation, the first guide wheel assembly and the second guide wheel assembly being selectively adjustably positionable between the first end and the second end of the first frame member.

2. The dock caddie according to claim 1, further comprising: a tray removeably supported in the frame.

3. The dock caddie according to claim 2, wherein the tray includes a plurality of trays, each of the plurality of trays including at least one compartment.

4. The dock caddie according to claim 2, further comprising a tray cover detachably connected to the tray.

5. The dock caddie according to claim 1, further comprising a first adjustable support member extending from the first frame member, the first adjustable support member supporting the first wheel and the first guide wheel assembly, and a second adjustable support member extending from the first frame member spaced from the first adjustable support member along the first frame axis, the second adjustable support member supporting the second wheel and the second guide wheel assembly.

6. The dock caddie according to claim 5, wherein the first adjustable support member includes a mounting plate configured to connect with the first frame member, the mounting plate including a first wheel support and a second wheel support, the first wheel being supported between the first wheel support and the second wheel support.

7. The dock caddie according to claim 6, wherein the first wheel includes a first wheel element and a second wheel element mounted to a first axle, the first axle being rotatably supported between the first wheel support and the second wheel support.

8. The dock caddie according to claim 6, further comprising a guide wheel support extending from the mounting plate, the first guide wheel assembly being selectively connected to the guide wheel support.

9. The dock caddie according to claim 8, wherein the guide wheel support includes a plurality of adjustment openings, each of the plurality of adjustment openings being spaced a selected distance from the mounting plate.

10. The dock caddie according to claim 9, further comprising a sleeve selectively connected to the guide wheel support through at least one of the plurality of adjustment openings.

11. The dock caddie according to claim 10, wherein the first guide wheel assembly includes a wheel yoke including a wheel mount supporting a wheel pin, the wheel pin being slidingly received by the sleeve.

12. The dock caddie according to claim 11, further comprising a spring arranged between the wheel yoke and the sleeve, the spring biasing the wheel yoke laterally outwardly from the first adjustable support member toward the first side surface of the first dock rail.

13. The dock caddie according to claim 9, wherein the first frame member includes an upper surface, a lower surface, and a first plurality of openings extending between the upper surface and the lower surface adjacent to the first end and a second plurality of openings extending between the upper surface and the lower surface adjacent to the second end.

14. The dock caddie according to claim 13, wherein the first adjustable support member is connected to the lower surface of the first frame member through select ones of the first plurality of openings and the second adjustable support member is connected to the lower surface of the first frame member through select ones of the second plurality of openings.

15. The dock caddie according to claim 14, wherein the first adjustable support member is spaced from the second adjustable support member such that the first wheel rests on the first top surface and the second wheel rests on the second top surface.

16. The dock caddie according to claim 15, wherein the guide wheel support is spaced from the first wheel such that the first guide wheel assembly rides along the first side surface.

17. The dock caddie according to claim 1, further comprising:
a third wheel configured to ride on the first top surface, the third wheel being arranged on the second frame member and being rotatable about the first axis;
a fourth wheel configured to ride along the second top surface, the fourth wheel being arranged on the second frame member and being rotatable about the first axis of rotation, the third wheel and the fourth wheel being selectively adjustably positionable between the first end portion and the second end portion;
a third guide wheel assembly configured to ride along the first side surface, the third guide wheel assembly being arranged on the second frame member and being rotatable about a second axis of rotation that is perpendicular relative to the first axis of rotation; and
a fourth guide wheel assembly configured to ride along the second side surface, the fourth guide wheel assembly being arranged on the second frame member and being rotatable about the second axis of rotation, the third guide wheel assembly and the fourth guide wheel assembly being selectively adjustably positionable between the first end portion and the second end portion.

18. The dock caddie according to claim 17, further comprising a motor mounted to the second frame member, the motor being operatively connected to one of the third wheel and the fourth wheel.

19. The dock caddie according to claim 18, further comprising a motor controller operatively connected to the motor, the motor controller being selectively activated to drive the dock caddie along the first dock rail and the second dock rail.

20. The dock caddie according to claim 19, wherein the motor controller includes an antenna, the motor controller being configured to receive wireless signals directing the dock caddie along the first dock rail and the second dock rail.
